(19) United States
(12) Patent Application Publication
(10) Pub. No.: US 2003/0098852 A1
(43) Pub. Date: May 29, 2003

(54) Optical mouse

(76) Inventors: Chien-Chang Huang, Hsin-Chu (TW); Jeng-Feng Lan, Hsin-Chu (TW)

Correspondence Address: FRANK R. OCCHIUTI, Fish & Richardson P.C., 225 Franklin Street, Boston, MA, 02110-2804, US

(21) Appl. No.: 10/304,888

(22) Filed: Nov. 26, 2002

(30) Foreign Application Priority Data
Nov. 27, 2001 (TW) 090129280

(51) Int. Cl. G09G 5/08

(52) U.S. Cl. 345/166

(57) ABSTRACT

An optical mouse for analyzing an image on the surface of an object to move an indicator on a computer screen. The optical mouse includes a housing, a lens holder, an EL element, a lens and a sensor. The lens holder is disposed in the housing and has a sidewall and a bay. The EL element is disposed on the sidewall of the lens holder and emits uniform light to the surface of the object to generate reflected light therefrom. The lens is disposed in the bay of the lens holder and images the reflected light to an imaging position. The sensor is disposed in the housing and in the imaging position and receives the reflected light to obtain the image from the surface of the object.

### BACKGROUND OF THE INVENTION

1. Field of the Invention

The present invention relates to an optical mouse, and more particularly to an optical mouse having an EL (Electro Luminescent) element.

2. Description of the Related Art

As shown in FIG. 1, a conventional optical mouse 1 includes a housing 2, a LED 3, a light guiding element 4, a lens 5, a lens holder 6 and a sensor 7. The lens 5 is disposed in the housing 2 by the lens holder 6.

When the LED 3 emits light B1 to the surface 8 of an object via the light guiding element 4, reflected light B2 is generated on the surface 8. Then, the reflected light B2 passes through the lens 5 and is received by the sensor 7. The sensor 7 captures the image of the reflected light B2 and transmits information of the image to an analyzing circuit 9. The analyzing circuit 9 compares the information of the current image with that of a previous image to obtain displacement of the optical mouse 1 on X and Y axes. Then, the indicator on a computer screen is moved according to the displacement obtained by the analyzing circuit 9.

Nevertheless, the conventional optical mouse 1 uses the LED 3, a tiny light source, as a light source. Since the emitting angle of the LED 3 is very small and the volume thereof is big, it is difficult for the LED 3 to accurately project light onto the surface 8 of the object. Thus, non-uniform reflected light is easily created on the surface 8 of the object.

Additionally, the light output from the LED 3 enters the light guiding element 4 and is refracted thereby to output uniform light to the surface 8 of the object. Because of the light guiding element 4, assembly of the conventional optical mouse 1 is complicated.

Further, the LED 3 consumes one-third of the total electricity required by the conventional optical mouse 1.

Thus, there is a need for an optical mouse using an EL element to replace the LED and light guiding element of the conventional optical mouse, thereby simplifying manufacture and conserving power.

### SUMMARY OF THE INVENTION

The present invention is directed to an optical mouse having an EL element. The EL element emits light to the surface of an object to generate uniform reflected light.

Accordingly, an object of the invention is to provide an optical mouse that analyzes an image on the surface of an object to move an indicator on a computer screen. The optical mouse includes a housing, a lens holder, an EL element, a lens and a sensor. The lens holder is disposed in the housing and has a sidewall and a bay. The EL element is disposed on the sidewall of the lens holder and emits uniform light to the surface of the object to generate reflected light thereon. The lens is disposed in the bay of the lens holder and images the reflected light to an imaging position. The sensor is disposed in the housing and on the imaging position and receives the reflected light to obtain the image from the surface of the object.

Preferably, the sensor is a CMOS sensor.

Preferably, the lens holder is transparent.

Preferably, the lens holder is a cone having a gradually tapered end, and the bay is on the gradually tapered end.

Preferably, the area of the EL element is substantially equal to or smaller than that of the sidewall of the lens holder.

Preferably, the EL element disposed on the sidewall of the lens holder is protected by the housing.

### DESCRIPTION OF THE DRAWINGS

For a better understanding of the present invention, reference is made to a detailed description to be read in conjunction with the accompanying drawings, in which:

FIG. 1 is a schematic view showing a conventional optical mouse;

FIG. 2 is a schematic cross section showing one optical mouse of the invention;

FIG. 3A is a schematic inner top view of the optical mouse of the invention;

FIG. 3B is a schematic inner cross section of the optical mouse of the invention;

FIG. 3C is a schematic inner bottom view of the optical mouse of the invention;

FIG. 4A is a schematic bottom view of the optical mouse of the invention;

FIG. 4B is a schematic cross section of the optical mouse of the invention;

FIG. 4C is a schematic top view of the optical mouse of the invention; and

FIG. 5 is a schematic view showing an EL element disposed under the lens holder of another optical mouse of the invention.

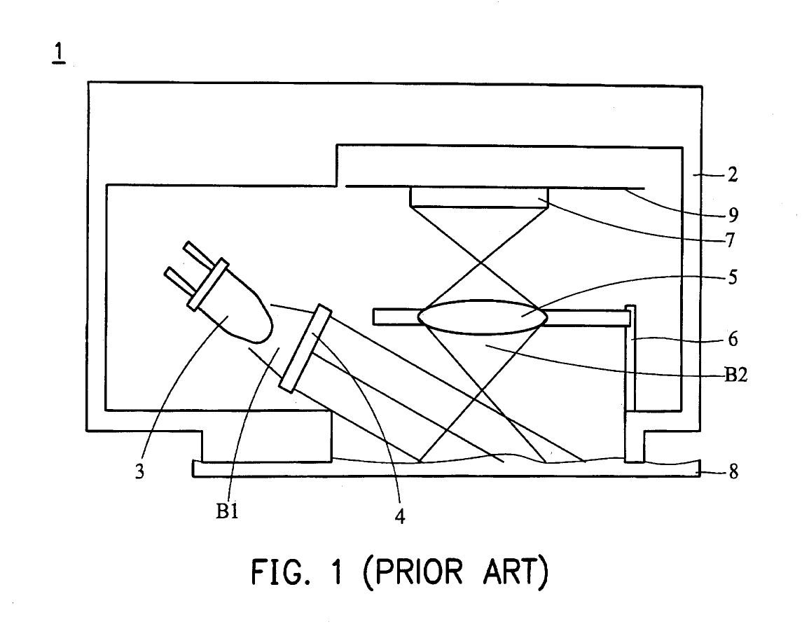

### DETAILED DESCRIPTION OF THE INVENTION

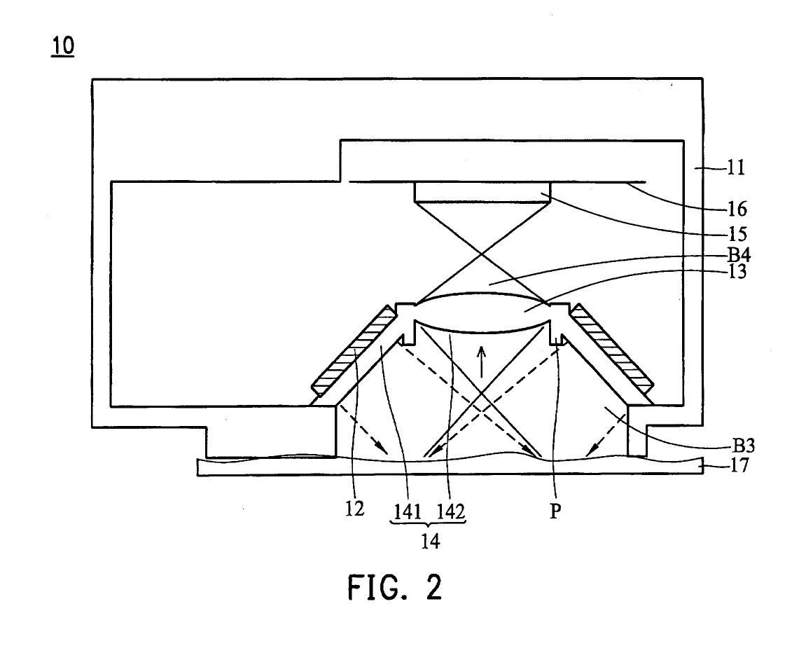

Referring to FIG. 2, the optical mouse 10 comprises a housing 11, an EL (Electro Luminescent) element 12, a lens 13, a lens holder 14 and a sensor 15. The lens holder 14 is disposed in the housing 11 and has a sidewall 141 and a bay 142. The EL element 12 is disposed on the sidewall 141 of the lens holder 14. The lens 13 is disposed in the bay 142 of the lens holder 14. The sensor 15 is disposed in the housing 11.

In this embodiment, the lens holder 14 is transparent. When the EL element 12 emits light B3, the light B3 passes through the lens holder 14 and reaches the surface 17 of an object. Then, reflected light B4 is generated on the surface 17 and passes through the lens 13. The lens 13 images the reflected light B4 to an imaging position. Additionally, the sensor 15 is disposed in the imaging position. The sensor 15 captures the image of the reflected light B4 and transmits information of the image to an analyzing circuit 16. The analyzing circuit 16 compares the information of the current image with that of a previous image to obtain displacement of the optical mouse 10 on X and Y axes. Then, the indicator on a computer screen (not shown) is moved to a suitable position according to the displacement obtained by the analyzing circuit 16. Specifically, a flange P is formed between the sidewall 141 and the bay 142 to screen other irrelevant light.

Specifically, the sensor 15 of the embodiment is a CMOS sensor disposed in the imaging position.

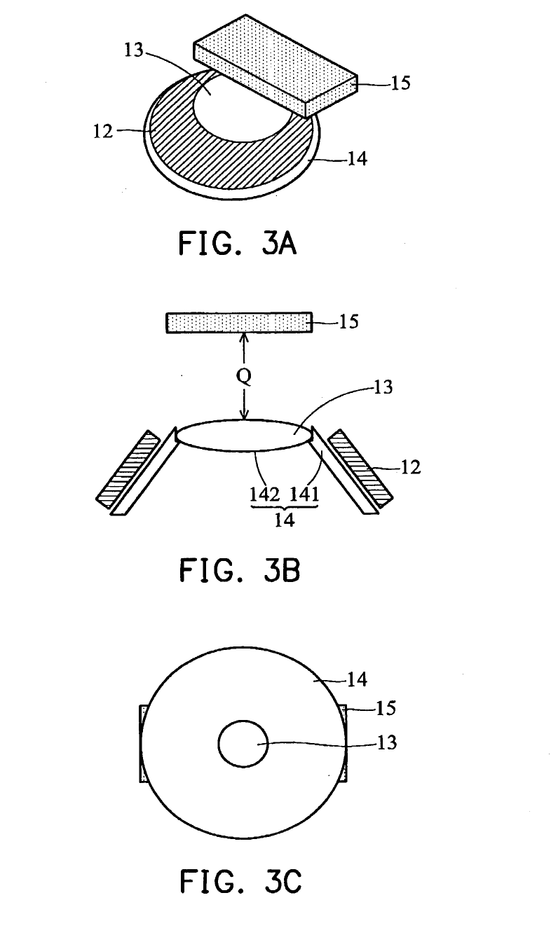

Referring to FIG. 3A, FIG. 3B and FIG. 3C, the lens holder 14 is a cone having a gradually tapered end. The bay 142 is on the gradually tapered end and the lens 13 is disposed in the bay 142. The CMOS sensor 15 is separated from the lens 13 by a distance Q.

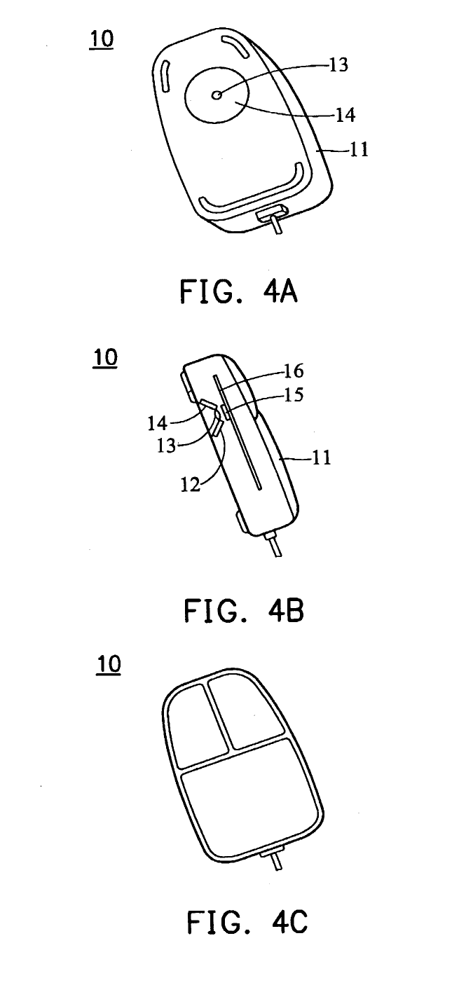

Referring to FIG. 4A, FIG. 4B and FIG. 4C, the lens holder 14 and the housing 11 can be integrally formed. The lens 13 is disposed on the lens holder 14. As shown in FIG. 4B, the EL element 12 is disposed on the lens holder, 14, and the CMOS sensor 15 is electrically connected to the analyzing circuit 16.

Specifically, the area of the EL element 12 is substantially equal to or smaller than that of the sidewall 141 of the lens holder 14.

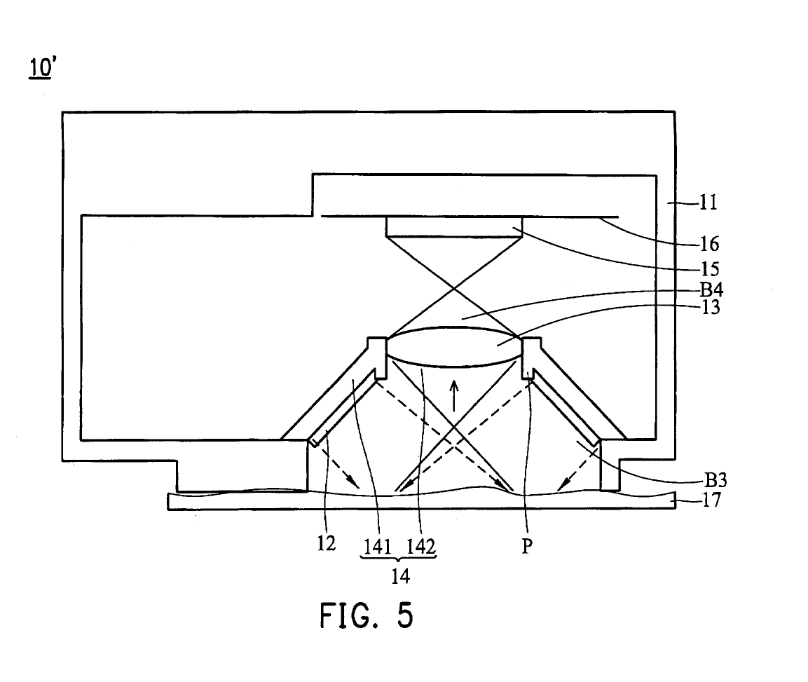

FIG. 5 is a schematic view showing another optical mouse 10′ of the invention. The EL element 12 can be disposed outside the optical mouse 10′. Namely, the EL element 12 is disposed under the sidewall 141 of lens holder 14, such that the EL element 12 is not inside the housing 11.

Similarly, the area of the EL element 12 is substantially equal to or smaller than that of the sidewall 141 of the lens holder 14.

To conclude, the invention has many advantages as follows.

(1) The EL element emits uniform light to the surface of an object, and thereby uniform reflected light is generated therefrom.

(2) The EL element conserves considerable power compared with an LED.

(3) The present optical mouse does not include a light guiding element, thus simplifying assembly and reducing manufacturing cost and volume thereof.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An optical mouse for analyzing an image on the surface of an object to move an indicator on a computer screen, comprising:
a housing;
a lens holder disposed in the housing and having a sidewall and a bay;
an EL element disposed on the sidewall of the lens holder for emitting uniform light to the surface of the object to generate reflected light thereon;
a lens disposed in the bay of the lens holder for imaging the reflected light to an imaging position; and
a sensor disposed in the housing and in the imaging position for receiving the reflected light to obtain the image from the surface of the object.

2. The optical mouse as claimed in claim 1, wherein the sensor is a CMOS sensor.

3. The optical mouse as claimed in claim 1, wherein the lens holder is transparent.

4. The optical mouse as claimed in claim 1, wherein the lens holder is a cone having a gradually tapered end, and the bay is on the gradually tapered end.

5. The optical mouse as claimed in claim 1, wherein the area of the EL element is substantially equal to or smaller than that of the sidewall of the lens holder.

6. The optical mouse as claimed in claim 1, wherein the EL element disposed on the sidewall of the lens holder is protected by the housing.

7. The optical mouse as claimed in claim 1, wherein the EL element is disposed under the sidewall of the lens holder and not protected by the housing.

8. An optical mouse for analyzing an image on the surface of an object to move an indicator on a computer screen, comprising:
a housing;
a lens holder disposed in the housing and having a sidewall and a cone having a gradually tapered end, wherein the gradually tapered end has a bay;
an EL element disposed on the sidewall of the lens holder for emitting uniform light to the surface of the object to generate reflected light thereon;
a lens disposed in the bay of the lens holder for imaging the reflected light to an imaging position; and
a CMOS sensor disposed in the housing and in the imaging position for receiving the reflected light to obtain the image from the surface of the object.

9. The optical mouse as claimed in claim 8, wherein the lens holder is transparent.

10. The optical mouse as claimed in claim 8, wherein the area of the EL element is substantially equal to or smaller than that of the sidewall of the lens holder.
